(19) United States
(12) Patent Application Publication
(10) Pub. No.: US 2023/0147983 A1
(43) Pub. Date: May 11, 2023

(54) Lattice-form support beam and solar tracker having such a beam

(71) Applicant: NEXANS, Courbevoie (FR)

(72) Inventors: Fabien VIENNOIS, MESSERY (FR); Christophe MICOLI, MARSEILLE (FR); Jérôme TORDO, Aix-En-Provence (FR)

(21) Appl. No.: 17/915,433

(22) PCT Filed: Apr. 1, 2021
(86) PCT No.: PCT/FR2021/050572

§ 371 Date: Sep. 28, 2022

(30) Foreign Application Priority Data
Apr. 8, 2020 (FR) 2003501

(51) Int. Cl. H02S 20/32

(52) U.S. Cl. CPC H02S 20/32

(57) ABSTRACT

The invention relates to a lattice-form support beam having three side members that extend in parallel in a main direction of extension of the beam and are connected together by cross members and tie rods via securing plates secured to the side members. Each securing plate (8c) secured to a given side member (4) has two radial flat fins (11a, 11b), each comprising a securing orifice. The first fin (11a) is used to removably secure the ends of a first cross member (6), of a first tie rod (9a) and of a second tie rod (9b), which are secured to one another by a first single bolt system (14) passing through the securing orifice of the first fin. The second fin (11b) is used to removably secure the ends of a second cross member (7), of a third tie rod (9c) and of a fourth tie rod (9d), which are secured to one another by a second single bolt system (17) passing through the securing orifice of the second fin.

### TECHNICAL FIELD

The present invention relates in a general manner to a lattice support beam comprising a plurality of parallel longitudinal members connected to one another by crossmembers and tie rods.

The invention relates more particularly to a lattice support beam of triangular cross section comprising:
a set of three longitudinal members extending in parallel along a main direction of extent of the beam,
a plurality of triangular assemblies distributed along the main direction of extent and each extending in a plane perpendicular to said main direction of extent, each triangular assembly being formed by three crossmembers mechanically connecting the longitudinal members in pairs,
a plurality of tie rods each mechanically connecting the longitudinal members in pairs while extending between two consecutive triangular assemblies, and
a plurality of fastening plates fastened to the longitudinal members in order to allow the fastening of the ends of the crossmembers and of the tie rods.

### TECHNOLOGICAL BACKGROUND

Such a lattice beam is already known and used in particular, as described in document WO 2018/033495, to serve as a support structure for a table of a solar tracker equipped with at least one solar energy collection device.

A solar tracker thus comprises the support beam which supports solar energy collection devices, for example photovoltaic block panels, and which is driven to rotate by a motorized drive device in order that the panels remain always oriented facing the sun throughout the day. The aim of such a rotatable structure is to increase the yield of the photovoltaic panels.

A great many (typically, from around one hundred to several thousand) solar trackers are generally installed on one and the same site of a free field solar power plant, more commonly referred to as a “solar farm”.

One of the major challenges is to ensure that the cost of the energy collected by a solar farm is as low as possible. This cost is reduced by increasing the yield of the solar farms, and also by reducing the costs for transporting and installing the solar trackers.

The lattice support beam as described in document WO 2018/033495 has a very large impact on the transport and installation costs on account, on the one hand, of the large number of components which have to be assembled together to form the beam, and, on the other hand, of the large volume of this beam.

In order to reduce the transport costs, it is already known to bring the various components onto the site of the solar farm which is to receive the solar trackers in order to assemble them directly at the intended locations.

FIGS. 1 and 2 give an example of a known lattice support beam 1 after assembly, FIG. 2 being an enlarged view of the region represented by a dotted circle in FIG. 1. The beam 1 in FIG. 1 comprises a set of three longitudinal members 2, 3 and 4 extending in parallel along a main direction of extent of the beam. Each longitudinal member consists of a metal tube or of a plurality of portions of metal tubes placed end to end along the main direction of extent.

The beam 1 further comprises crossmembers 5, 6 and 7 for maintaining a spacing between the three longitudinal members 2, 3 and 4 while giving the lattice support beam 1 a triangular cross section. More precisely, with the beam 1 being used, in this nonlimiting example, as a support beam for a table of a solar tracker:
the two longitudinal members 2 and 3 here respectively constitute a first upper longitudinal member and a second upper longitudinal member (on which the table (not shown) is intended to rest), whereas the longitudinal member 4 constitutes a lower longitudinal member; and
the crossmembers 5, 6 and 7 are distributed along the main direction of extent and mechanically connect the longitudinal members in pairs such that each group of crossmembers 5, 6 and 7 forms a triangular assembly extending in a plane perpendicular to the main direction of extent of the longitudinal members.

In the Following:
the crossmembers 5 constitute upper crossmembers which connect the first upper longitudinal member 2 to the second upper longitudinal member 3;
the crossmembers 6 constitute first lateral crossmembers which connect the first upper longitudinal member 2 to the lower longitudinal member 4; and
the crossmembers 7 constitute second lateral crossmembers which connect the second upper longitudinal member 3 to the lower longitudinal member 4.

FIG. 1 thus illustrates three groups of crossmembers 5, 6, 7 forming three consecutive triangular assemblies each extending in a plane perpendicular to the main direction of extent of the beam 1.

The ends of the crossmembers 5, 6 and 7 forming one and the same triangular assembly are fastened to the three longitudinal members 2, 3 and 4 by means of three intermediate parts or fastening plates 8a, 8b, 8c, themselves fastened respectively to the longitudinal members 2, 3 or 4, for example by riveting. In order to fasten a plurality of triangular assemblies, a plurality of fastening plates must therefore be fastened, preferably at regular intervals, along each longitudinal member 2, 3 or 4. Thus, FIG. 1 shows:
three fastening plates 8a fastened at regular intervals to the first upper longitudinal member 2;
three fastening plates, such as the plates 8b, fastened at regular intervals to the second upper longitudinal member 3; and
three fastening plates 8c fastened at regular intervals to the lower longitudinal member 4.

As more particularly visible in the enlarged region shown in FIG. 2, a fastening plate 8c is thus fastened by rivets to the lower longitudinal member 4 to serve for fastening to the lower ends of a first lateral crossmember 6 and of a second lateral crossmember 7.

In order to stiffen the support beam, the latter further comprises a plurality of tie rods 9 (schematically illustrated by lines in FIG. 1) each mechanically connecting the longitudinal members in pairs while extending between two consecutive triangular assemblies. The two ends of each tie rod are also fastened to the fastening plates 8a, 8b or 8c.

Thus, as more particularly visible in the enlarged region shown in FIG. 2, the fastening plates 8c serve for fastening not only to the lower ends of the two lateral crossmembers 6 and 7, but also to the respective ends of four tie rods 9 (only two tie rods having been shown in FIG. 2). For this purpose, in the nonlimiting case illustrated where the longitudinal members have a tubular shape, each fastening plate 8c comprises a central surface 10 matching the outer shape of the longitudinal members and also two flat flanges 11a and 11b laterally prolonging the central surface 10 and extending radially with respect to the longitudinal member 4. The flat flanges 11a and 11b each comprise three through-holes, such as the hole referenced 12, to allow the fastening of the ends of one crossmember and of two tie rods by as many bolting systems, these ends of crossmembers and of tie rods moreover comprising a flat fastening region provided with a through-orifice facing a through-hole 12 for the assembly operation. Thus, as visible in FIG. 2:
the flat flange 11a comprises a first hole for fastening one end of a first tie rod 9 (the other end of which, visible in FIG. 1, is fastened to the upper crossmember 2 via a fastening plate 8a), a second hole for fastening the crossmember 6, and a third hole for fastening one end of a second tie rod (not shown);
the flat flange 11b comprises a first hole for fastening one end of a third tie rod 9, a second hole for fastening the crossmember 7, and a third hole for fastening one end of a fourth tie rod (not shown).

As will have been understood, each fastening plate 8a, 8b or 8c allows the fastening of one end of two crossmembers belonging to one and the same triangular assembly and of one end of four tie rods whose second ends are fastened for their part to other fastening plates.

In the case where it is wished to obtain equilateral triangular assemblies (for which the upper crossmembers 5 and the first and second lateral crossmembers 6 and 7 have the same length), the fastening plates 8a, 8b, 8c are advantageously all identical, and each comprise two flat flanges 11a, 11b forming between them an angle substantially equal to 60°. In the case where it is wished to obtain isosceles triangular assemblies (in which case only the first and second lateral crossmembers 6 and 7 have the same length), the fastening plates 8c fastened to the lower longitudinal member 4 each comprise two flat flanges 11a, 11b forming between them an angle substantially equal to 90°, whereas the fastening plates 8a and 8b, which are fastened respectively to the upper longitudinal members 2 and 3, each comprise two flat flanges 11a, 11b forming between them an angle substantially equal to 45°.

In all the cases, six bolting systems are therefore required, each system comprising a screw and a nut, in order to fasten the ends of two crossmembers and of four tie rods to one and the same fastening plates 8a, 8b or 8c.

The use of these fastening plates thus increases the costs, on the one hand, of manufacture and, on the other hand, of mounting the lattice support beams.

Furthermore, all the forces of the tie rods and crossmembers pass through the fastening plate, which must be accordingly dimensioned to withstand large forces without risk of deformation in the flat flanges 11a, 11b, or of an effect of the plate being pulled out with respect to the longitudinal member to which it is fastened.

### SUMMARY OF THE INVENTION

The present invention proposes to overcome the disadvantages of the prior art by proposing lattice support beams similar to the one shown in FIG. 1, but for which the fastening plates have been modified.

More particularly, the subject of the present invention is a lattice support beam of triangular cross section comprising:
a set of three longitudinal members extending in parallel along a main direction of extent of the beam,
a plurality of triangular assemblies distributed along the main direction of extent and each extending in a plane perpendicular to said main direction of extent, each triangular assembly being formed by three crossmembers mechanically connecting the longitudinal members in pairs,
a plurality of tie rods each mechanically connecting the longitudinal members in pairs while extending between two consecutive triangular assemblies,
a plurality of fastening plates fastened to the longitudinal members, each fastening plate fastened to a given longitudinal member among the three longitudinal members comprising a first flat flange and a second flat flange extending radially with respect to said given longitudinal member, the first flat flange forming a first fastening surface for the removable fastening of one end of a first crossmember among said plurality of crossmembers, of one end of a first tie rod and of one end of a second tie rod among said plurality of tie rods, and the second flat flange forming a second fastening surface for the removable fastening of one end of a second crossmember among said plurality of crossmembers, of one end of a third tie rod and of one end of a fourth tie rod among said plurality of tie rods,
   characterized in that the end of the first crossmember, the end of the first tie rod and the end of the second tie rod are fastened together by a single first bolting system comprising a fastening screw passing through one and the same fastening orifice of the first flat flange, and in that the end of the second crossmember, the end of the third tie rod and the end of the fourth crossmember are fastened together by a single second bolting system comprising a fastening screw passing through one and the same fastening orifice of the second flat flange.

According to one possible embodiment, each fastening plate fastened to a given longitudinal member comprises a central surface matching the outer shape of said given longitudinal member, said first flat flange and said second flat flange laterally prolonging the central surface while extending radially with respect to the given longitudinal member.

According to one possible embodiment, each fastening plate is secured to the given longitudinal member by means of rivets at the central surface.

According to one possible embodiment, the end of the first crossmember is preferably fastened to an inner face of the first flat flange, whereas the end of the first tie rod and the end of the second tie rod are fastened to an outer face of the first flat flange, and the end of the second crossmember is fastened to an inner face of the second flat flange, whereas the end of the third tie rod and the end of the fourth tie rod are fastened to an outer face of the second flat flange.

According to one possible embodiment, the end of the first tie rod and of the third tie rod, respectively, is in contact with the outer face of the first flat flange and the outer face of the second flat flange, respectively.

In this embodiment, the end of the second tie rod and of the fourth tie rod, respectively, preferably comprises a play-compensating device.

According to one possible embodiment, said one and the same fastening orifice of the first flat flange and of the second flat flange, respectively, is preferably situated at the center of the first flat flange and of the second flat flange, respectively.

According to one possible embodiment, said set of three longitudinal members consists of a lower longitudinal member, of a first upper longitudinal member and of a second upper longitudinal member, and each triangular assembly comprises an upper crossmember connecting the first upper longitudinal member to the second upper longitudinal member, a first lateral crossmember connecting the first upper longitudinal member to the lower longitudinal member, and a second lateral crossmember connecting the second upper longitudinal member to the lower longitudinal member, the first end and the second end of each upper crossmember of a given triangular assembly being fastened directly respectively to a first fastening plate of said plurality of fastening plates fastened to the first upper longitudinal member and to a second fastening plate of said plurality of fastening plates fastened to the second upper longitudinal member, the first end and the second end of each first lateral crossmember of said given triangular assembly being fastened directly respectively to the first fastening plate and to a third fastening plate of said plurality of fastening plates fastened to the lower longitudinal member,

and the first end and the second end of each second lateral crossmember of said given triangular assembly being fastened directly respectively to the second fastening plate and to the third fastening plate.

In one possible embodiment, the upper crossmembers and the first and second lateral crossmembers have the same length so as to obtain equilateral triangular assemblies, and the first flat flange and the second flat flange of each of the first, second and third fastening plates form, between them, an angle substantially equal to 60°.

In a variant, the first and second lateral crossmembers have the same length so as to obtain isosceles triangular assemblies, the first flat flange and the second flat flange of each of the first and second fastening plates form between them an angle substantially equal to 45°, and the first flat flange and the second flat flange of the third fastening plate form between them an angle substantially equal to 90°.

A beam according to this embodiment can, for example, support a table of a solar tracker, said table being equipped with at least one solar energy collection device and resting on the first upper longitudinal member and on the second upper longitudinal member.

### BRIEF DESCRIPTION OF THE FIGURES

The description given below with regard to the appended drawings, given by way of nonlimiting examples, will give a clear understanding of what the invention consists of and how it can be implemented. In the appended figures:

FIG. 1, already described above, shows an example of a known lattice support beam;

FIG. 2, already described above, illustrates an enlargement of a part of the lattice support beam of FIG. 1;

FIG. 3 shows two partial views (a) and (b) illustrating, from two different angles, an example of fastening tie rods and crossmembers to a fastening plate fastened to a lower longitudinal member of a lattice support beam, according to one possible embodiment of the present invention.

### DESCRIPTION OF EMBODIMENT(S)

In the figures, and unless stated otherwise, elements which are identical or similar will bear the same reference signs.

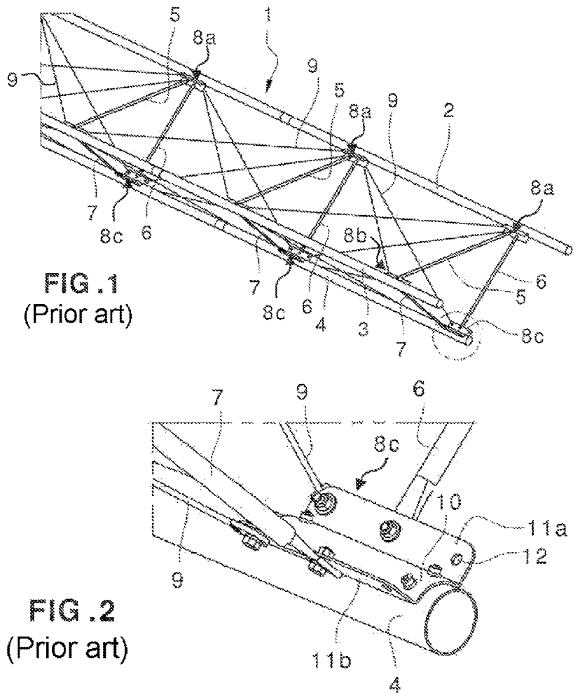

As has been indicated above, the invention relates to a lattice support beam similar to the one shown in FIG. 1, the various common elements (longitudinal members 2, 3, 4 and crossmembers 5, 6 and 7 forming the triangular assemblies) of which will not be described again. In the following, only the modification made to the fastening plates according to the invention will be presented.

It is assumed in the following, in a nonlimiting manner, that the first and second lateral crossmembers 6, 7 described above all have the same length so as to obtain isosceles triangular assemblies. It will be recalled that, in this case, the first fastening plates 8a and the second fastening plates 8b, respectively fastened to the upper longitudinal members 2 and 3, must each comprise two flat flanges forming between them an angle substantially equal to 45°, whereas the third fastening plates 8c, fastened to the lower longitudinal member 4, must each comprise two flat flanges forming between them an angle substantially equal to 90°. Since the three fastening plates 8a, 8b and 8c differ in this case only in terms of the angle formed by the flat flanges, the description which follows will, for the sake of simplification, describe the principle of the invention for the fastening plate 8c.

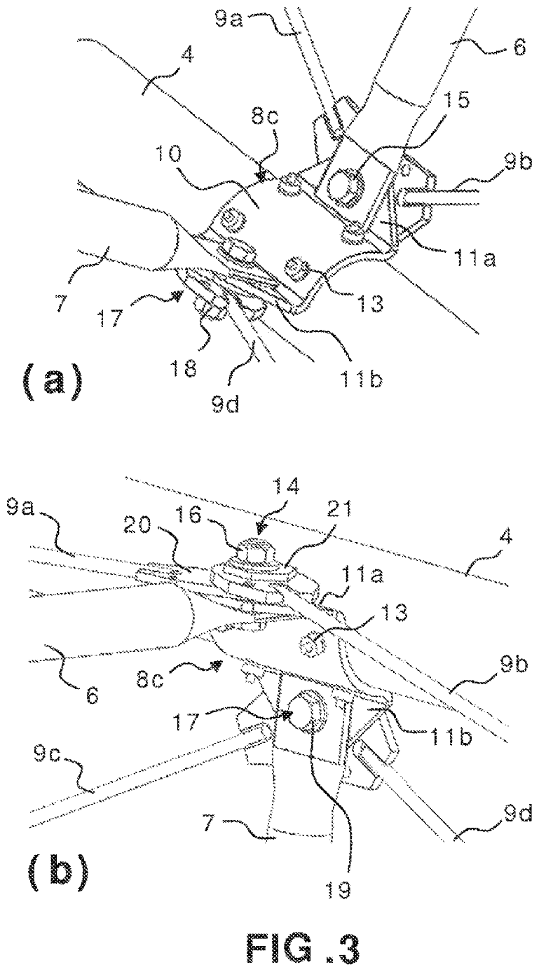

Thus, FIG. 3 depicts two partial views (a) and (b) showing a fastening plate 8c fastened to the lower longitudinal member 4 of the lattice beam structure. The fastening plate 8c therefore replaces, according to the invention, the fastening plate 8c illustrated in FIG. 2.

As has been indicated above, the fastening plate 8c comprises a central surface 10 matching the outer shape of the longitudinal member 4 and two flat flanges 11a and 11b laterally prolonging the central surface 10 and extending radially with respect to the longitudinal member 4 while forming between them an angle substantially equal to 90°. The fastening plate 8c is secured to the longitudinal member preferably by means of four rivets 13 at the central surface 10. The first flat flange 11a forms a first fastening surface for the removable fastening of one end of a first crossmember, here the first lateral crossmember 6, of one end of a first tie rod 9a and of one end of a second tie rod 9b. The second flat flange 11b forms a second fastening surface for the removable fastening of one end of a second crossmember, here the second lateral crossmember 7, of one end of a third tie rod 9c and of one end of a fourth tie rod 9d among said plurality of tie rods.

However, unlike the plate 8c of FIG. 2 which comprises six through-holes 12, each flat flange 11a and 11b of the fastening plate 8c here comprises, according to the invention, a single fastening orifice, preferably situated at its center. Thus, as visible in FIG. 3, the end of the first crossmember 6, the end of the first tie rod 9a and the end of the second tie rod 9b are fastened together by a single first bolting system 14 comprising a fastening screw 15 passing through the fastening orifice of the first flat flange 11a, and a clamping nut 16. Similarly, the end of the second crossmember 7, the end of the third tie rod 9c and the end of the fourth tie rod 9d are fastened together by a single second bolting system 17 comprising a fastening screw 18 passing through the fastening orifice of the second flat flange 11b, and a clamping nut 19.

The ends of the crossmembers 6 and 7 are preferably fastened to the inner faces of the flat flanges 11a and 11b, that is to say the faces of the flanges that face one another, whereas the ends of the tie rods 9a, 9b, 9c, 9d are preferably fastened to the outer faces of the flat flanges 11a and 11b.

In one possible embodiment, the ends of the two tie rods which are fastened to one and the same flat fastening flange are identical, and are conventionally formed by a flattened end piece fastened or integrated to or with one end of the longitudinal body of the tie rod (see, for example, the flattened end 20 for the tie rod 9a in FIG. 4) pierced with a circular through-opening to allow the passage of the screw of the bolting system.

In another embodiment, one end of one of the two tie rods further comprises a play-compensating device, for example an eccentric washer making it possible to vary the fastening center distance between the two ends of this tie rod. In the case of FIG. 3, the end of the tie rod 9b, on the one hand, and of the tie rod 9d, on the other hand, comprises such a play-compensating device 21. In this embodiment, in order to facilitate the mounting operations, the tie rods whose end does not comprise a play-compensating device (namely the first tie rod 9a and the third tie rod 9c of FIG. 3) are preferably mounted first such that their respective end is in contact with the fastening surface formed by the corresponding flat flange. The tie rods whose end comprises a play-compensating device (namely the second tie rod 9b and the fourth tie rod 9d of FIG. 3) are then mounted above such that their respective end is in contact with the end of the tie rod mounted first.

In all the cases, the use of fastening plates conforming to what has just been described makes it possible to divide by three the number of bolting systems necessary for the mounting of the lattice beam structure, which allows mounting time to be saved and contributes to a reduction in the total weight of the lattice support beam.

Furthermore, since two tie rods and one crossmember are held at a single point for each flat flange 11a, 11b, the forces of these two tie rods and of this crossmember are transmitted first of all to the screw of the associated bolting system before being transmitted to the fastening plate. Simulations have in particular made it possible to show that, in one and the same loading situation, a fastening plate such as the fastening plate 8c of FIG. 3 receives up to 70% less force than the fastening plate 8c of FIG. 2.

Moreover, the fact that the direction of the forces of the two tie rods and of one crossmember passes through the center of the corresponding flat flange makes it possible to reduce the risks of pull-out of the fastening plate with respect to the longitudinal member, and of deformation of the flat flanges.

Since the fastening plate is subjected directly to less force, it is also possible to reduce its size, more precisely the length of its central surface 10 and of the flat flanges 11a, 11b in the longitudinal direction of the longitudinal member 4, by half with respect to the fastening plate 8c of FIG. 2. This results in a reduction by half of the weight of each fastening plate used for the mounting of a lattice support beam, which further contributes to a reduction in the total weight of the lattice support beam.

The same advantages as those described above are of course obtained in the case where the lattice support beam comprises equilateral triangular assemblies. In this case, all the fastening plates fastened to the three longitudinal members are identical and each comprise two flat flanges forming between them an angle equal to substantially 60°.

1. A lattice support beam of triangular cross section comprising:
a set of three longitudinal members extending in parallel along a main direction of extent of the beam,
a plurality of triangular assemblies distributed along the main direction of extent and each extending in a plane perpendicular to said main direction of extent, each triangular assembly being formed by three crossmembers mechanically connecting the longitudinal members in pairs,
a plurality of tie rods each mechanically connecting the longitudinal members in pairs while extending between two consecutive triangular assemblies,
a plurality of fastening plates fastened to the longitudinal members, each fastening plate fastened to a given longitudinal member among the three longitudinal members comprising a first flat flange and a second flat flange extending radially with respect to said given longitudinal member, the first flat flange forming a first fastening surface for the removable fastening of one end of a first crossmember among said plurality of crossmembers, of one end of a first tie rod and of one end of a second tie rod among said plurality of tie rods, and the second flat flange forming a second fastening surface for the removable fastening of one end of a second crossmember among said plurality of crossmembers, of one end of a third tie rod and of one end of a fourth tie rod among said plurality of tie rods,
wherein the end of the first crossmember, the end of the first tie rod and the end of the second tie rod are fastened together by a single first bolting system comprising a fastening screw passing through one and the same fastening orifice of the first flat flange, and in that the end of the second crossmember the end of the third tie rod and the end of the fourth tie rod are fastened together by a single second bolting system comprising a fastening screw passing through one and the same fastening orifice of the second flat flange.

2. The lattice support beam as claimed in claim 1, wherein each fastening plate fastened to a given longitudinal member comprises a central surface matching the outer shape of said given longitudinal member, said first flat flange and said second flat flange laterally prolonging the central surface while extending radially with respect to the given longitudinal member.

3. The lattice support beam as claimed in claim 2, wherein each fastening plate is secured to the given longitudinal member by means of rivets at the central surface.

4. The lattice support beam as claimed in claim 1, wherein the end of the first crossmember is fastened to an inner face of the first flat flange, whereas the end of the first tie rod and the end of the second tie rod are fastened to an outer face of the first flat flange, and in that the end of the second crossmember is fastened to an inner face of the second flat flange, whereas the end of the third tie rod and the end of the fourth tie rod are fastened to an outer face of the second flat flange.

5. The lattice support beam as claimed in claim 4, wherein the end of the first tie rod and of the third tie rod, respectively, is in contact with the outer face of the first flat flange and the outer face of the second flat flange, respectively.

6. The lattice support beam as claimed in claim 5, wherein the end of the second tie rod and of the fourth tie rod,
respectively, comprises a play-compensating device.

7. The lattice support beam as claimed in claim 1, wherein said one and the same fastening orifice of the first flat flange and of the second flat flange, respectively, is situated at the center of the first flat flange and of the second flat flange, respectively.

8. The lattice support beam as claimed in claim 1, wherein said set of three longitudinal members includes a lower longitudinal member, of a first upper longitudinal member and of a second upper longitudinal member, and each triangular assembly comprises an upper crossmember connecting the first upper longitudinal member to the second upper longitudinal member, a first lateral crossmember connecting the first upper longitudinal member to the lower longitudinal member, and a second lateral crossmember connecting the second upper longitudinal member to the lower longitudinal member, the first end and the second end of each upper crossmember of a given triangular assembly being fastened directly respectively to a first fastening plate of said plurality of fastening plates fastened to the first upper longitudinal member and to a second fastening plate of said plurality of fastening plates fastened to the second upper longitudinal member,
the first end and the second end of each first lateral crossmember of said given triangular assembly being fastened directly respectively to the first fastening plate and to a third fastening plate of said plurality of fastening plates fastened to the lower longitudinal member,
and the first end and the second end of each second lateral crossmember of said given triangular assembly being fastened directly respectively to the second fastening plate and to the third fastening plate.

9. The lattice support beam as claimed in claim 8, wherein the upper crossmembers and the first and second lateral crossmembers have the same length so as to obtain equilateral triangular assemblies, and in that the first flat flange and the second flat flange of each of the first, second and third fastening plates form between them an angle substantially equal to 60°.

10. The lattice support beam as claimed in claim 8, wherein the first and second lateral crossmembers have the same length so as to obtain isosceles triangular assemblies, and in that the first flat flange and the second flat flange of each of the first and second fastening plates form between them an angle substantially equal to 45°, in that the first flat flange and the second flat flange of the third fastening plate form between them an angle substantially equal to 90°.

11. A solar tracker comprising a lattice support beam as claimed in claim 9, said lattice support beam supporting a table of a solar tracker equipped with at least one solar energy collection device and resting on the first upper longitudinal member and on the second upper longitudinal member.
